(19) United States
(12) Patent Application Publication
(10) Pub. No.: US 2004/0189030 A1
(43) Pub. Date: Sep. 30, 2004

(54) Adjustable roll handling hoist

(76) Inventors: William J. Briggs JR., Roy, UT (US); Michael Haasl, North Ogden, UT (US)

Correspondence Address: KIMBERLY-CLARK WORLDWIDE, INC., 401 NORTH LAKE STREET, NEENAH, WI, 54956

(21) Appl. No.: 10/403,188

(22) Filed: Mar. 31, 2003

(51) Int. Cl. B66C 1/54

(52) U.S. Cl. 294/67.22

(57) ABSTRACT

A roll handling hoist defining a vertical direction and an x-y plane perpendicular to the vertical direction. The roll handling hoist includes a rigid vertical support assembly, and a chuck assembly movably joined to the rigid vertical support assembly. The chuck assembly may be configured to move in the vertical direction and to be adjustable between a plurality of roll configurations. The roll handling hoist also includes a user control assembly joined to the vertical support assembly. The user control assembly may maintain a fixed position relative to the vertical support assembly when the chuck assembly is moved in the vertical direction.

### FIELD OF THE INVENTION

The present invention relates to material handling equipment such as hoists. In particular, the present invention relates to roll handling hoists.

### BACKGROUND OF THE INVENTION

Hoists are often used in industrial applications to pick up and move machinery, converting materials and other equipment and articles that may be too large or too heavy for an individual to lift by hand. In a particular application, hoists may be used to move materials from staging areas to their appointed location within a converting process. In such situations, the materials may be provided on a roll, and be taken from a staging area and placed upon a spindle for use in a converting process by an operator. While hoists and roll handlers exist for such applications, they may not always be entirely satisfactory.

For example, individual roll handlers may not be suited to accommodate the various roll diameters and roll widths that may be used in a single converting process. Moreover, certain roll handlers may be able to accommodate material rolls of a particular size, but may not be able to accept rolls of widely varying weights. Thus, with space in a manufacturing environment often at a premium, having several material handling devices for each type of material is an undesirable option. As a result, one material handling device is often used to handle several different configurations of material rolls. However, in order to accommodate several roll configurations, this single device is often not well suited for any one particular roll of material, leading to possible safety issues. For example, the device may include a chuck that is used to engage the rolls via the core of the roll. However, to accommodate varying roll sizes, the device may be sized such that it may not fully and securely engage a wide roll, but when the same device is used in connection with a smaller roll, the size of the device may cause it to unintentionally engage multiple rolls rather that just a single roll. Either situation presents a safety hazard and could potentially lead to material contamination if a roll were to accidentally slip off of the chuck. Similarly, where rolls may vary by weight in addition to or instead of varying by size, a single device may be ill-equipped to handle rolls of differing weight.

Further, ergonomic considerations of the user are often compromised with certain roll handling devices. For example, problems that have been encountered in the past include the physical strain associated with the need to at least partially push rolls of material off poorly adapted roll handling devices and to their appointed destination, particularly if the destination is located at an elevation. Further, it may be difficult to readily move some roll handling devices in an x-y plane. In situations where a material handling device has been suspended from above, such as with an I-beam and trolley combination, the material handling device could be awkward for an operator to use since such designs have at times been prone to swinging in addition to requiring an undesired level of exertion to move through a limited range of motion.

Accordingly, despite the attempts to develop improved material handling hoists, there remains a need for roll handling hoists that can provide the benefits of being able to suitably accommodate rolls of varying size and weight while also improving ease of use and ergonomics for the user. That is, there remains a need for a roll handling hoist that includes an easily adjustable chuck assembly, has a wide range of motion in both the vertical direction and in the x-y plane, and is designed for ease of operator use and designed to reduce the amount of physical strain necessary to operate the hoist.

### SUMMARY OF THE INVENTION

In response to the difficulties and problems discussed above, a new roll handling hoist has been discovered. In one aspect the present invention concerns a roll handling hoist defining a vertical direction and an x-y plane perpendicular to the vertical direction. The roll handling hoist includes a rigid vertical support assembly and a chuck assembly movably joined to the vertical support assembly, the chuck assembly being configured to move in the vertical direction and to be adjustable between a plurality of roll configurations. The roll handling hoist further includes a user control assembly joined to the vertical support assembly where the user control assembly maintains a fixed position relative to the vertical support assembly when the chuck assembly is moved in the vertical direction.

In another aspect the present invention concerns a roll handling hoist defining a vertical direction and an x-y plane perpendicular to the vertical direction. The roll handling hoist includes a vertical support assembly defining a vertical axis parallel to the vertical direction and a chuck assembly movably joined to the rigid vertical support assembly, the chuck assembly being configured to move in the vertical direction and to be adjustable between a plurality of roll configurations. The roll handling hoist further includes a user control assembly joined to the vertical support assembly and a visual alignment system where vertical support assembly is configured to rotate about the vertical axis, and the user control assembly maintains a fixed position relative to the vertical support assembly when the chuck assembly is moved in the vertical direction.

In yet another aspect the present invention concerns a roll handling hoist defining a vertical direction and an x-y plane perpendicular to the vertical direction. The roll handling hoist includes a rigid vertical support assembly defining a vertical axis parallel to the vertical direction and a chuck assembly movably joined to the vertical support assembly, the chuck assembly including an open chuck and being configured to move in the vertical direction and to be adjustable between a plurality of roll configurations. The roll handling hoist further includes a user control assembly joined to the vertical support assembly and a visual alignment system where the vertical support assembly is configured to rotate about the vertical axis, and where the user control assembly maintains a fixed position relative to the vertical support assembly when the chuck assembly is moved in the vertical direction.

In still yet another aspect the present invention concerns a roll handling hoist defining a vertical direction. The roll handling hoist includes a rigid vertical support assembly and a chuck assembly movably joined to the vertical support assembly. The chuck assembly is configured to move in the vertical direction and includes one or more roll interaction features each having selectable operating conditions where the operating conditions of the roll interaction features define a particular arrangement of roll settings for the chuck assembly. The roll handling hoist also includes a user control assembly operatively connected to the roll interaction features. The user control assembly being operable to select the operating condition for each of the roll interaction features for a particular roll configuration.

### BRIEF DESCRIPTION OF THE DRAWINGS

The present invention will be more fully understood and further advantages will become apparent when reference is made to the following detailed description of the invention and the accompanying drawings wherein like numerals represent like elements. The drawings are merely representative and are not intended to limit the scope of the appended claims.

FIG. 1 representatively illustrates a perspective view of an embodiment of a hoist of the present invention;

FIG. 2 representatively illustrates a front elevation view of the hoist of FIG. 1;

FIG. 3 representatively illustrates a right side elevation view of the hoist of FIG. 1;

FIG. 4 representatively illustrates a perspective view of the hoist of FIG. 1 where the hoist of the present invention includes a transfer system; and

FIG. 5 representatively illustrates an example of a pneumatic piping schematic for use with a hoist of the present invention.

### DETAILED DESCRIPTION OF THE INVENTION

The present invention concerns hoists, and more specifically material handling hoists capable of lifting and moving materials in roll form, such as raw materials that are unwound into a converting process, or wound finished products produced in a manufacturing process. Accordingly, the present invention will be described in terms of a material roll handling hoist. Nonetheless, it will be understood by those of skill in the art that the apparatus of the present invention will be equally adaptable to other material handling equipment such as fork-trucks, cranes, roll handlers, winches, and the like.

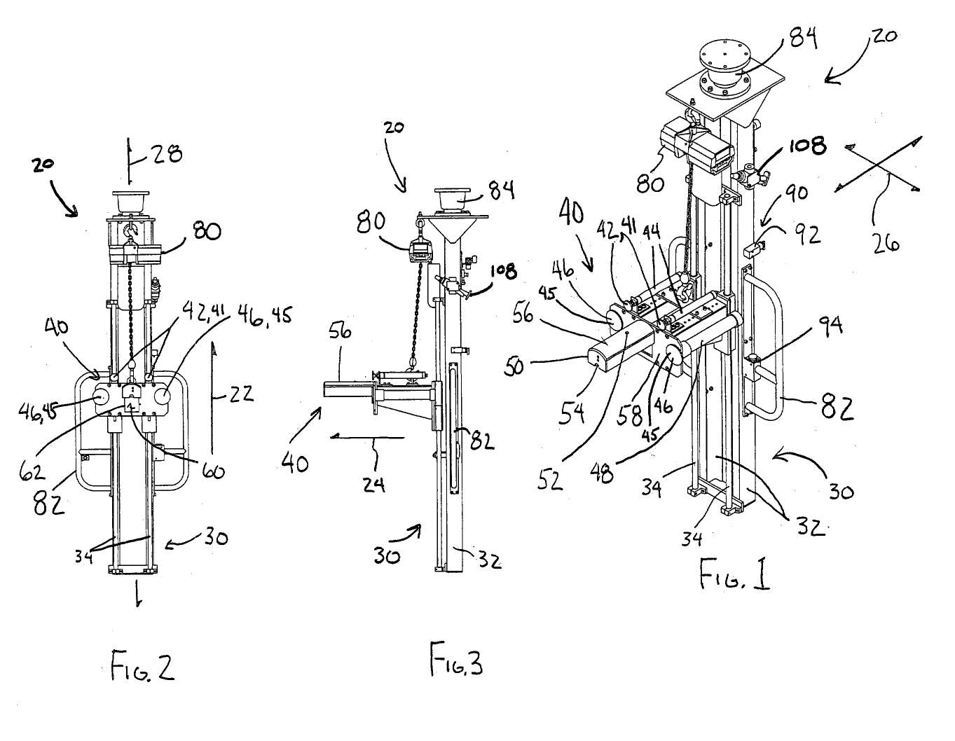

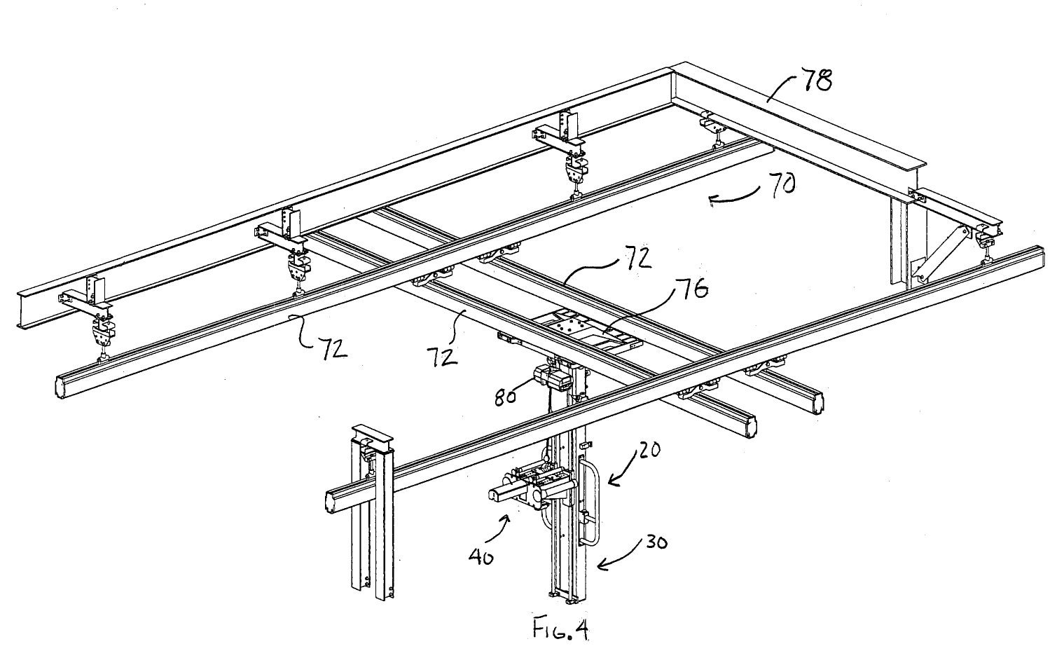

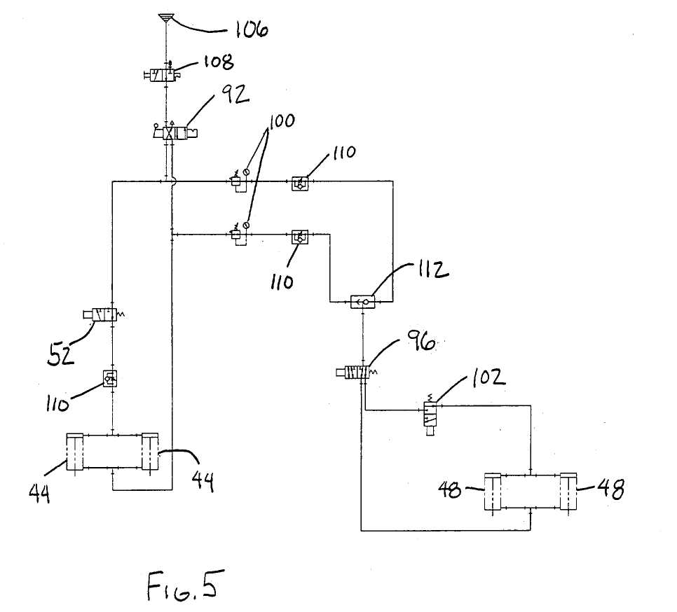

FIG. 1 representatively illustrates a hoist, as generally indicated at 20, of the present invention. FIG. 2 representatively illustrates a front elevation view of the hoist of FIG. 1, and similarly, FIG. 3 representatively illustrates a right side elevation view of the hoist of FIG. 1. FIG. 4 representatively illustrates a perspective view of an alternative aspect of the present invention where the hoist includes a transfer system, as generally indicated at 70. Referring to FIGS. 1, 2 and 3, there is representatively illustrated an aspect of the present invention where the hoist defines a vertical direction 22 and a horizontal direction 24. The hoist 20 further defines an x-y plane 26 that is perpendicular to the vertical direction 22.

The illustrated hoist 20 includes a rigid vertical support assembly 30. The support assembly 30 defines a vertical axis 28 that is parallel to the vertical direction 22. The hoist 20 also includes a chuck assembly 40 that is movably joined to the vertical support assembly 30 and is configured to move up and down in the vertical direction 22. In addition, the hoist 20 may further include a user control assembly 90 that allows the operator to direct the various features of the hoist 20.

The various components of the hoist 20 may be assembled together using techniques as are well known in the art. For example, the components may be joined together using bolts, screws, welding, rivets, and the like or combinations thereof. As used herein, the term “join” or “joined” refers to either the direct or indirect attachment of one component to another. Components may be permanently attached to one another or may also be releasably attached to one another and still fall within the meaning of “join” or “joined” as used herein.

The vertical support assembly 30 of the hoist 20 may be provided by a variety of structures as are well known in the art to provide the necessary strength and stability for the hoist. As such, the hoist 20 may include at least one frame member 32. In one aspect, the vertical support assembly may include a plurality of spaced apart frame members 32. In such a configuration, the space between the frame members 32 may facilitate the use of a visual alignment system 60, as will be discussed in greater detail below. In a particular aspect, as representatively illustrated in FIGS. 1 and 2, the vertical support assembly includes a pair of spaced apart frame members 32. Desirably, the vertical support assembly 30 is a rigid vertical support assembly such that, when in use, the hoist 20 is less likely to substantially swing out of parallel with the vertical direction 22 thus reducing the effort required of the operator when trying to maneuver the hoist 20.

Rigid frame members 32 may be provided by extruded metal or composite material such as angle iron, tubing, or the like. For example, in a particular embodiment, the frame members 32 may suitably be constructed from aluminum channel. Optionally, the roll handling hoist 20 may also include at least one handle 82 joined to the vertical support assembly 30. Desirably, as representatively illustrated in FIGS. 1 and 2, the roll handling hoist 20 includes at least two handles for improved maneuverability and ease of use. For example, the illustrated roll handling hoist 20 includes a pair of handles extending from the frame members 32 of the vertical support assembly 30.

The hoist 20 may also include a winch 80 joined to the vertical support assembly 30. The winch 80 may be configured to move the chuck assembly 40 in at least the vertical direction 22. Specifically, the hoist 20 may include a chain or cabling, or other suitable connection between the winch 80 and the chuck assembly 40. Thus, the winch 80 may be capable of raising and lowering the chuck assembly 40 in the vertical direction 22. As such, the hoist 20 may be capable of moving a material roll up and down from one elevation to another. Suitable winches are well known to those skilled in the art and are available from Columbus McKinnon Corporation, a business having offices in Amherst, N.Y. Alternatively, other methods for raising and lowering the chuck assembly 40 may be employed such as hydraulic pumps, a screw drive, a pneumatic balancer, or the like.

The chuck assembly 40 of the various aspects of the present invention is the portion of the hoist 20 that engages the material or item to be transferred from a first location to a second location. In the case of a roll of material, the chuck assembly 40 may include a chuck 50 that extends substantially in the horizontal direction 24 from a chuck frame 58. As such, the chuck 50 may be configured to be placed within the hollow core of a material roll so that the material roll may then be picked up by the hoist 20 and transferred to another location.

As mentioned above, the chuck assembly 40 is movably joined to the vertical support assembly 30. That is, the chuck assembly 40 may be configured to move in at least the vertical direction 22, thus allowing rolls of material to be raised or lowered while using the hoist 20. As such, the chuck assembly 40 may be joined to the vertical support assembly 30 in a number of ways as are well known in the art. For example, as representatively illustrated in FIGS. 1-4, the vertical support assembly 30 may include at least one slide rod 34 joined to one of the frame members 32 upon which the chuck assembly 40 is movably joined. In such an arrangement, the chuck assembly 40 may be configured to slidably move in the vertical direction 22 on the slide rod 34. In a particular aspect, there may be a slide rod 34 joined to each of the frame members 32 for improved performance and steadiness of the chuck assembly in use. The slide rods 34 of the hoist 20 may be provided by extruded aluminum or steel rails. In a particular aspect, the slide rods 34 may be Thompson Rods available from Thompson Industries, a company having offices in Port Washington, N.Y.

The chuck 50 may be of various lengths in the horizontal direction 24 as dictated by the application for which the hoist 20 is intended. For instance, for material rolls, the chuck is desirably longer in the horizontal direction 24 so as to ensure secure engagement with the core of the material roll and to decrease the opportunity of having the material roll slide off of the chuck. Moreover, the chuck 50 may be of various shapes as is well known in the art. For example, the chuck 50 may be round, oval, rectangular, or the like as is well known in the art. Desirably, at least a portion of the chuck 50 may be arcuate to enhance stability of the roll upon the chuck and to decrease the possibility of deforming the interior of the core of the roll with the exterior surface of the chuck 50.

In one aspect, the chuck 50 may be an open chuck. That is, as representatively illustrated in FIGS. 1 and 2, the chuck 50 may have an incomplete circular shape having an arcuate top surface 56 but otherwise having substantially rectilinear shaped surfaces. In such a configuration, the chuck 50 may advantageously be capable of securely engaging rolls having a larger core diameter, yet since the overall cross-sectional dimension of the chuck is smaller than what it would have been had the chuck 50 been completely circular, the chuck 50 also provides the hoist 20 with the ability to engage rolls having a smaller core diameter. Further, since the arc of the circle forming the top surface 56 of the chuck 50 is not completed, the open chuck configuration may facilitate the operation of the visual alignment system 60, as will be described in greater detail below.

In addition, an open chuck design provides the hoist 20 a chuck assembly 40 that is configured to engage off-vertical rolls. As used herein, “off-vertical” is used to describe a roll that may be tilted or otherwise skewed so that its cylindrical cross section is not parallel with the vertical direction 22. In one aspect, the chuck assembly 40 may be configured to engage a roll that is up to 10% off-vertical. In another aspect, the chuck assembly 40 may be configured to engage a roll that is up to 15% off-vertical. In still another aspect, the chuck assembly may be configured to engage a roll that is up to 20% off-vertical.

As has been discussed above, material rolls may come in numerous diameters and roll widths. Moreover, material rolls may have similar sizes but may be of widely varying weights depending on the nature of the material on the roll. Finally, material rolls may vary in both weight and size. Thus, it is desirable for a single hoist to be capable of being readily adapted to safely and ergonomically accommodate multiple roll configurations. As used herein, the term “roll configuration” refers to the size, for example in the width dimension of the roll, and/or weight of the roll for a particular roll of material. Moreover, rather than having the user of the hoist 20 physically push the roll off of the chuck and on to the spindle, it is desirable that the chuck assembly 40 be capable of fully pushing the roll of material off of the chuck 50. This is particularly the case where the roll of material is particularly heavy, or when the roll of material must be transported to an elevated location, as such situations can exert undue physical strain upon an operator. Further it is desirable that the chuck assembly 40 be capable of fully pushing material from the chuck 50 regardless of whether the chuck assembly 40 is configured for a large roll or a narrow roll. Still further, it is desirable that the chuck assembly 40 be capable of adjusting the force used to push the materials off of the chuck 50 depending on the weight of the material.

Accordingly, to address these needs the hoist 20 may include a chuck assembly 40 where the free length of the chuck 50 may be adjusted such that it will fully accommodate only a single roll of a certain size at one time. Such an arrangement advantageously prevents an operator from accidentally engaging multiple rolls of material if the free length of the chuck 50 is too large for a single roll of a particular roll width. As used herein, the “free length” refers to that portion of the total chuck length in the horizontal direction 24 that is available to engage a roll of material. Similarly, in another aspect, the chuck assembly 40 is capable of varying the force with which the rolls may be pushed off of the chuck 50 to desirably accommodate different material rolls that vary by weight as well as by width. Thus, the chuck assembly 40 of the hoist 20 can also be advantageously adjustable between a plurality of roll configurations, as described.

The adjustment of the hoist 20 for rolls of varying size and weight may be accomplished by including a backing plate system 41 in the chuck assembly 40 that can adjust the free length of the chuck 50. Specifically, the chuck assembly 40 may include a backing plate system 41 having at least one backing plate 42 that is configured to be adjustable between a plurality of roll sizes. Alternatively, as representatively illustrated in FIGS. 1 and 2, the chuck assembly 40 may also include multiple backing plates 42. Specifically, the backing plates 42 may be used to shorten the overall length of the chuck 50 in the horizontal direction 22. As such, the free length of the chuck 50 is being adjusted using the backing plate system 41. Thus, if a narrow roll of material were to be engaged by the chuck 50, the backing plate system 41 may operate to extend the backing plates 42 to shorten the free length of the chuck 50. Likewise, if a wider roll of material were to be engaged by the chuck 50, the backing plate system 41 may operate to retract the backing plates 42 to then enlarge the free length of the chuck 50. It should be noted that the backing plates 42 cannot be retracted to enlarge the free length of the chuck 50 beyond the overall length of the chuck 50.

Subsequently, upon transporting the material to the desired location, the backing plate 42 may then be extended by the backing plate system 41 up to or just beyond the full length of the chuck 50 to push the material off of the chuck 50 to the desired destination. In such an arrangement, the backing plate system 41 may include a backing plate 42 mounted to at least one linear actuator that may be programmed for a variety of roll sizes and weights. Suitable linear actuators are well known to those skilled in the art and are available from Warner Electric, a business having offices in South Beloit, Ill.

Alternatively, to reduce the complexity and manufacturing costs of the hoist 20, the chuck assembly 40 may optionally be made adjustable using pneumatic actuation. In such an arrangement, the backing plate system 41 may include backing plates 42 and backing plate cylinders 44. As such, backing plates 42 are adjusted from one position to another as described above using backing plate cylinders 44. Suitable pneumatic cylinders are well known in the art and are available from Bimba Manufacturing Corporation, a business having offices in Monee, Ill. Alternatively, other apparatus may be used to actuate the backing plates 42, such as a hydraulic actuator.

In yet another alternative, the chuck assembly 40 of the various aspects of the hoist 20 may also include a push-off plate system 45. For instance, the push off plate system 45 may include at least one push-off plate 46 and one push-off plate cylinder 48. This is particularly advantageous where pneumatics are being used in the chuck assembly 40 for reduced complexity. As representatively illustrated in FIGS. 1 and 2, the chuck assembly 40 may include a push-off plate system 45 that may alternatively include multiple push-off plates 46 and multiple push-off plate cylinders 48. The push-off plates 46 may be used to force the material roll off of the chuck 50 when the desired location for the material is reached. For example, the hoist 20 may be used to transport a roll of material to a unwind spindle in a converting process. Rather than have the user physically push the roll off of the chuck and on to the spindle, the user may instead trigger the extension of the push-off plates 46 to transfer the material roll from the chuck 50 to the spindle.

The push-off plates 46 may be triggered using the push-off plate cylinders 48. In a particular aspect, telescoping pneumatic cylinders may be used such that the overall cylinder length does not impede the operation of the hoist 20 or become an obstacle to the operator. Suitable pneumatic cylinders are well known in the art and are available from Ergo-Help Inc., a business having offices in Arlington Heights, Ill. Alternatively, other apparatus may be used in the push-off plate system 45 to actuate the push-off plates 46, such as a screw drive or a hydraulic actuator.

As discussed above, it may be desirable to control the force with which the push-off plates 46 extend to accommodate rolls of differing weights. Thus, the push-off plate system 45 of the chuck assembly 40 may be configured to be adjustable between a plurality of roll weights. For example, push-off plate cylinders 48 may be actuated at a first pressure for heavier rolls, and alternatively may be actuated at a second lower pressure for less heavy rolls. As such, the push-off plates 46 may operate at a suitable pressure to adequately move heavier materials, yet may also operate at a different pressure such that lighter material rolls are not over-powerfully pushed from the chuck, which could potentially result in damage to the material and could also present a potential safety hazard.

The hoist 20 also includes a user control assembly 90. In a particular aspect, the user control assembly 90 may include an actuator 92. Therefore, adjusting the chuck assembly 40 from a first roll configuration to a second roll configuration may be accomplished using only the actuator 92. Desirably, the user may select between multiple roll configurations by using only the actuator 92. For example, actuator 92 may be a switch that may select between multiple configurations of the chuck assembly 40 for multiple rolls that may have various sizes and/or weights. Specifically, in a particular aspect where the chuck assembly 40 is adjusted from a first roll configuration to a second roll configuration using a pneumatic system, the actuator 92 may toggle between different pneumatic set ups to obtain the adjustments necessary. Thus, it should be readily apparent to those of skill in the art that the chuck assembly may be capable of being adapted for several different rolls of differing sizes and weights. For instance, in the circumstances where pneumatics are being employed to provide adjustability to the chuck assembly, the proper pneumatic pressure and stop locations for the backing plates 42 need only determined to provide the required pneumatic system for each roll configuration. Accordingly, the operator may then readily switch between differing roll configurations by using the actuator 92 to select the desired pneumatic system for the roll configuration that is to be transferred.

In a particular aspect, one or any combination of components of the hoist 20 may automatically be adjusted when switching from a first roll configuration to a second roll configuration using an actuator 92. For example, the backing plate system 41 may extend or retract the backing plates 42 to the proper position such that the free length of the chuck 50 is suited for the particular roll. In addition, the push off plate system 45 may also adjust to accommodate the weight of the particular roll that is being moved. That is, in one aspect, the amount of pneumatic pressure may be raised or lowered such that the push-off plate 46 extends with an adequate amount of force to push the roll of material off of the chuck 50. Moreover, the winch 80 may also be adjusted upon the operator making a selection using an actuator 92. That is, the amount of force with which the winch 80 raises or lowers the chuck assembly 40 may be adjusted according to the weight of the roll that the operator selects. Thus, as mentioned, the hoist 20 may be configured to be adjustable between a plurality of roll configurations.

A suitable pneumatic piping schematic is representatively illustrated in FIG. 5. In particular, FIG. 5 illustrates a pneumatic system for use on a hoist that is configured for two different rolls of differing size and weight. As illustrated, the mill air supply 106 provides the compressed air for the system. The system may include at least one dump valve 108, flow control valves 110 and at least one shuttle valve 112 for ease of use and improved performance and safety. That is, in the illustrated embodiment, the operator may make a roll configuration selection at the actuator 92. Provided that the dump valve 108 is closed, the mill air supply 106 will flow through the actuator 92 into the selected piping scheme that is designed for a particular roll configuration. As such, the backing plate system 41 via backing plate cylinders 44 will position the backing plates 42 in the proper position for the roll configuration selected. Optionally, a flow control valve 110 may be used to control the speed with which the backing plates 42 extend or retract. In addition, if desirable in view of the roll configuration selected at the actuator 92, the push-off plate system 45 may also be simultaneously adjusted. Specifically, the mill air 106 may flow through the desired piping scheme and thus through a regulator 100 that may set the air pressure flowing to the push-off cylinders 48 at the desired pressure. As such, if the roll configuration is for a heavy roll, the pressure set at the regulator 100 may be accordingly high such that the roll may be adequately pushed-off the chuck 50 by the push-off system 45 when desired by the operator. Alternatively, if the roll configuration is for a less heavy roll, the selected piping scheme may direct the mill air 106 through a regulator 100 that is set for a lower pressure such that the roll is not pushed off the chuck 50 too forcefully by the push-off system 45.

In a particular aspect, such a system may be used to configure the chuck assembly 40 for a first roll that is 12 inches wide and approximately 300 pounds and also for a second roll that is 5 inches wide and approximately 50 pounds. In such an arrangement, an operative pneumatic pressure of 70 PSI to 90 PSI may be suitable for the first roll described above, while an operative pneumatic pressure of 30 PSI to 50 PSI may be suitable for the second roll described above. As discussed above, this pressure may be set using regulators 100. Such regulators are well known in the art and are available from Norgren Company, a business having offices in Littleton, Colo.

As a result of the various components and capabilities of the chuck assembly 40 described above, the chuck assembly 40 may include one or more roll interaction features. As used herein, the term “roll interaction features” refers to the capability of the chuck assembly 40 to be automatically configured for various rolls of differing size and/or weight. For example, one roll interaction feature may include the backing plate system 41, that is capable of varying the free length of the chuck 50 to accommodate rolls of varying widths, as described above. Similarly, another roll interaction feature may include the push-off plate system 45, which can vary the force with which rolls are pushed off of the chuck 50. In particular, each of the roll interaction features may be automatically arranged into certain selectable operating conditions for different roll configurations. As used herein, the term “selectable operating conditions” refers to a particular setting for one of the roll interaction features that may be arrived at for a certain roll configuration. For instance, a selectable operating condition can include using the backing plate system 41 to extend or retract the backing plate 42 to a particular position. Another selectable operating condition may be a particular force setting for the push-off plate system 45 for pushing rolls off of the chuck 50. The operating conditions of the roll interaction features therefore define a particular arrangement of roll settings for the chuck assembly 40 that may be selected by the operator for a certain roll configuration. Accordingly, the user control assembly 90 may be operatively connected to the roll interaction features so that the operator may select the desired operating condition for the roll that is to be transported. Thus, the user control assembly 90 is operable to select an operating condition for each roll interaction feature. In a particular aspect, the operator may select the desired operating condition for each roll interaction feature that must be modified to accommodate a particular roll configuration in a single step.

The elements of the hoist 20 that provide the user control assembly 90 may be joined to the vertical support assembly 30. In particular, at least a portion of the user control assembly 90 may be joined to at least one of the handles 82 of the hoist 20 that are joined to the vertical support assembly 30. Further, in addition to the actuator 92, the user control assembly 90 may include at least one switch 94 for raising and lowering the chuck assembly 40, and in addition, a push-off plate actuator 96 for activating the push-off plates 46 (FIG. 5). In one aspect, the user control assembly 90 may remain in a fixed position relative to the vertical support assembly 30 when the chuck assembly is moved in the vertical direction 22. Such an arrangement maintains the user control assembly 90 in a convenient and ergonomically appropriate position for the operator regardless of the position of the chuck assembly 40.

As representatively illustrated in FIG. 4, the roll handling hoist 20 may also include a transfer system 70. A transfer system suitably allows the hoist 20 to be maneuvered by the operator such that materials may be picked up with the hoist 20 in a first location and readily delivered to a second destination location. Thus a transfer system 70 may be joined to the vertical support assembly 30 of the hoist 20 and be configured to allow the vertical support assembly 30 to move in the x-y plane 26. Moreover, the transfer system 70 may desirably be configured such that the vertical support assembly 30 may rotate about the vertical axis 28. In one aspect, the vertical support assembly 30 may be configured to rotate at least 90 degrees about the vertical axis 28. In another aspect the vertical support assembly 30 may be configured to rotate at least 180 degrees about the vertical axis 28. In a particular aspect, the vertical support assembly 30 may be configured to rotate fully about said vertical axis 28.

The transfer system 70 of the hoist 20 may include any mechanism known to those skilled in the art. For example, the vertical support assembly 30 may be fitted with casters allowing the user to maneuver the hoist 20 in the x-y plane 26. Alternatively, the transfer system 70 may include a set of tracks laid upon the floor in the desired hoist transfer area.

In yet another alternative, as representatively illustrated in FIG. 4, the transfer system 70 may be provided by a system of orthogonal rails 72 that are suspended from the existing building structure 78 over the desired hoist transport area. As such, the transfer system 70 may also include a carriage 76 that is joined to the top of the vertical support assembly 30 and is configured to slidably travel on the set of rails in the x-y plane 26. In such an arrangement, the hoist 20 may generally be suspended from the transfer system 70 leaving a gap between the hoist 20 and floor of the transfer area. Desirably, the hoist 20 may be guided by the user via the use of the orthogonal rails 72 with a relatively low amount of effort. Further, as representatively illustrated in FIGS. 1 and 3, rotating carriage mount 84 may be used to join the top of the vertical support assembly 30 to the carriage 76. As such, the rotating carriage mount 84 may allow the vertical support assembly 30 to rotate about the vertical axis 28 while also being capable of traveling in the x-y plane 26. A suitable system of orthogonal rails 72, carriage 76 and rotating carriage mount 84 are all available from Ingersoll-Rand Zimmerman Handling Systems, a business having offices in Rochester Hills, Mich.

Particular embodiments of the roll handling hoist 20 may also include a visual alignment system 60 (FIG. 2). The visual alignment system allows the user of the hoist 20 to readily align the chuck assembly 40 to facilitate the engagement of the chuck assembly 40 with the materials that are to be transported. In addition, the visual alignment system 60 also may be used when unloading materials from the chuck assembly 40. This is particularly helpful as hoists are generally arranged so that the operator is directing the hoist while located behind the hoist. As such, the visual alignment system 60 can allow for the safe and precise use of the hoist 20 while the operator is positioned behind the hoist. For example, when using the hoist 20 to pick up a roll of material, the visual alignment system 60 may be used to align the chuck 50 with the open core of the roll. Then, if the user is delivering the roll to an unwind spindle in a converting process, the user may align the chuck 50 with the spindle to ensure the roll can be easily placed on the spindle.

The visual alignment system 60 of the hoist 20 may be provided in various ways as are known to those skilled in the art. For example the visual alignment system 60 may include a camera joined to the chuck assembly. Such an arrangement may include a complimentary monitor where the user may view the alignment of the chuck assembly. Alternatively, the visual alignment system 60 may include at least one mirror that allows the operator to view the chuck assembly 40 from behind the hoist

20. In yet another alternative, the visual alignment system 60 may include a visual access port 62 located in the chuck frame 58 of the chuck assembly 40. Such a port 62, particularly when used in combination with spaced apart vertical frame members 32 and an open chuck design, would allow the operator to view the alignment of the chuck assembly 30 from behind the hoist 20. This arrangement provides a simple yet suitable visual alignment system 60 while likewise reducing the cost to manufacture the hoist 20.

In addition to the numerous advantages listed above, the hoist 20 may additionally include further safety features. For example, the push-off plates 46 may be rendered inoperative unless the chuck 50 is in contact with the appointed unloading location. Specifically, in one aspect, the chuck 50 may include a sensor 102 (FIG. 5) located on the interior of the chuck 50 adjacent to a notch 54 in the chuck 50. The sensor 102 may be triggered when the desired material destination is reached. In the case where a user is unloading a material roll onto a spindle, the sensor 102 may be located adjacent notch 54 and may be configured to be triggered only when mated with the spindle, then allowing the user to activate the push-off pates 46. For example, the spindle may be fitted with a key that, when the chuck 50 is in the proper position, becomes seated in notch 54, thereby allowing the push-off plates 46 to be activated.

Another safety feature that the hoist 20 may include is a mechanism to prevent the backing plates 42 from moving when materials are loaded upon the chuck assembly 40. This would ensure that materials could not be inadvertently discharged from the chuck assembly 40, which could result in injury or in a loss of material due to contamination. For example, chuck 50 may include an interlock 52 that is depressed when a material roll is on the chuck 50. The interlock 52 can be configured to prevent the backing plates 42 from extending while depressed. Thus, in such an arrangement, the free length of the chuck 50 in the horizontal direction 24 may be adjusted only when there is no material on the chuck assembly 40.

Particular aspects of the hoist of the present invention advantageously provide a material handling hoist that includes a chuck assembly that is capable of being adjusted to better accommodate material rolls of varying size and weights. The free length of the chuck may be modified to accommodate material rolls of differing widths, and the force with which material rolls are pushed off of the chuck may be adjusted to accommodate material rolls of differing weights. Moreover, certain aspects of the present invention also provide a hoist that is capable of an expansive range of motion in the x-y plane as well as rotational mobility. Further, this level of mobility is possible while the hoist control assembly of the present invention is maintained in a constant position relative to the vertical support members for enhanced safety and ease of use. Still further, certain aspects of the present invention may also provide a hoist that includes a visual alignment system, thus allowing the user to more easily and safely align the chuck assembly of the hoist with the appointed destination of the material being transferred. As a result, the roll handling hoist of the present invention are designed to safely accommodate a plurality of differing material rolls while improving the ease of use for the operator as well as maintaining an ergonomically sound hoist design.

While the invention has been described in rather great detail with respect to specific aspects thereof, it will be appreciated that those skilled in the art, upon attaining an understanding of the foregoing, may readily conceive of alterations to, variations of and equivalents to these aspects. Accordingly, the scope of the present invention should be assessed as that of the appended claims and any equivalents thereto.

We claim:

1. A roll handling hoist defining a vertical direction and an x-y plane perpendicular to said vertical direction, said roll handling hoist comprising:
a rigid vertical support assembly;
a chuck assembly movably joined to said vertical support assembly, said chuck assembly being configured to move in said vertical direction and to be adjustable between a plurality of roll configurations; and
a user control assembly joined to said vertical support assembly;
wherein said user control assembly maintains a fixed position relative to said vertical support assembly when said chuck assembly is moved in said vertical direction.

2. The hoist of claim 1 further comprising a visual alignment system.

3. The hoist of claim 2 wherein said visual alignment system comprises a visual access port in said chuck assembly.

4. The hoist of claim 2 wherein said visual alignment system comprises a camera.

5. The hoist of claim 1 further comprising a winch joined to said vertical support assembly, wherein said winch is configured to move said chuck assembly in said vertical direction.

6. The hoist of claim 1 further comprising a transfer system joined to said vertical support assembly, wherein said transfer system is configured to allow said vertical support assembly to move in said x-y plane.

7. The hoist of claim 6 wherein said transfer system comprises a carriage joined to said vertical support assembly and a system of rails joined to said carriage wherein said carriage is configured to slidably travel on said set of rails in said x-y plane.

8. The hoist of claim 1 further comprising at least one handle joined to said vertical support assembly.

9. The hoist of claim 8 wherein at least a portion of said user control assembly is attached to said at least one handle.

10. The hoist of claim 1 wherein said vertical support assembly comprises a plurality of spaced apart vertical frame members.

11. The hoist of claim 10 wherein said vertical support assembly further comprises at least one slide rod joined to one of said vertical frame members, and said chuck assembly is configured to slidably move in said vertical direction on said at least one slide rod.

12. The hoist of claim 1 wherein said chuck assembly is configured to engage off-vertical rolls.

13. The hoist of claim 1 wherein said chuck assembly further comprises an open chuck.

14. The hoist of claim 1 wherein said user control assembly comprises an actuator, and wherein said chuck assembly is adjusted from a first roll configuration to a second roll configuration only using said actuator.

15. The hoist of claim 1 wherein said chuck assembly comprises at least one backing plate configured to be adjustable between a plurality of roll sizes.

16. The hoist of claim 1 wherein said chuck assembly comprises at least one push-off plate configured to be adjustable between a plurality of roll weights.

17. A roll handling hoist defining a vertical direction, said roll handling hoist comprising:
a rigid vertical support assembly defining a vertical axis parallel to said vertical direction;
a chuck assembly movably joined to said vertical support assembly, said chuck assembly being configured to move in said vertical direction and to be adjustable between a plurality of roll configurations;
a user control assembly joined to said vertical support assembly; and
a visual alignment system;
wherein said vertical support assembly is configured to rotate about said vertical axis, and said user control assembly maintains a fixed position relative to said vertical support assembly when said chuck assembly is moved in said vertical direction.

18. The hoist of claim 17 wherein said chuck assembly comprises an open chuck.

19. The hoist of claim 17 wherein said visual alignment system comprises a visual access port in said chuck assembly.

20. The hoist of claim 17 wherein said chuck assembly is configured to engage off-vertical rolls.

21. The hoist of claim 17 wherein said user control assembly comprises an actuator, and wherein said chuck assembly is adjusted from a first roll configuration to a second roll configuration only using said actuator.

22. The hoist of claim 17 wherein said chuck assembly comprises at least one backing plate configured to be adjustable between a plurality of roll sizes.

23. The hoist of claim 17 wherein said chuck assembly comprises at least one push-off plate configured to be adjustable between a plurality of roll weights.

24. A roll handling hoist defining a vertical direction, said roll handling hoist comprising:
a rigid vertical support assembly defining a vertical axis parallel to said vertical direction;
a chuck assembly movably joined to said vertical support assembly, said chuck assembly comprising an open chuck and being configured to move in said vertical direction and to be adjustable between a plurality of roll configurations;
a user control assembly joined to said vertical support assembly; and
a visual alignment system;
wherein said vertical support assembly is configured to rotate about said vertical axis, and said user control assembly maintains a fixed position relative to said vertical support assembly when said chuck assembly is moved in said vertical direction.

25. A roll handling hoist defining a vertical direction, said roll handling hoist comprising:
a rigid vertical support assembly;
a chuck assembly movably joined to said vertical support assembly and being configured to move in said vertical direction, said chuck assembly comprising one or more roll interaction features each having selectable operating conditions wherein said operating conditions of said roll interaction features define a particular arrangement of roll settings for said chuck assembly; and
a user control assembly operatively connected to said roll interaction features, said user control assembly operable to select said operating condition for each of said roll interaction features for a particular roll configuration.

26. A hoist of claim 25 wherein said operating condition for each of said roll interaction features is selected by the operator in a single step.
